(19) United States
(12) Patent Application Publication
(10) Pub. No.: US 2011/0087526 A1
(43) Pub. Date: Apr. 14, 2011

(54) Social Network Economy Using Gift Credits

(76) Inventors: Jared Morgenstern, Palo Alto, CA (US); Joel Seligstein, Mountain View, CA (US); Soleio Cuervo, Palo Alto, CA (US); Huai Wang, Palo Alto, CA (US); Mark E. Zuckerberg, Palo Alto, CA (US); William Chen, Palo Alto, CA (US); Man-hay Tam, Belmont, CA (US); Vishu Gupta, Atherton, CA (US)

(21) Appl. No.: 12/753,345

(22) Filed: Apr. 2, 2010

Related U.S. Application Data
(60) Provisional application No. 61/166,244, filed on Apr. 2, 2009.

(51) Int. Cl. G06Q 99/00; G06Q 30/00

(52) U.S. Cl. 705/14.1; 705/319

(57) ABSTRACT

In a social networking system environment, users can give another user credits, a scarce commodity, as part of commenting on content posted by the other user. These credits can be used as a peer-to-peer recommendation signal, and they can also be used as input to a decision engine that determines what content to display in a highlights section that will be viewed by a wider audience and increasing the likelihood of further engagement with the content. Credits in a social networking system environment have scarcity value. In various embodiments, in order to increase the number of credits in the system, users buy them or an administrator distributes them. In some implementations, the total amount of credits in the system can decrease if a user cashes out the credits for real money. In some implementations, credits can be used to buy virtual or real-world gifts.

### CROSS-REFERENCE TO RELATED APPLICATIONS

This application claims the benefit of U.S. Provisional Application 61/166,244, filed on Apr. 2, 2009, and incorporated by reference herein in its entirety.

### BACKGROUND

The present invention relates generally to social networking systems, and more particularly to promoting the visibility of and engagement with content through providing users the ability to allocate resources to content deemed valuable.

Conventionally, users of social networking websites can post content that they wish to enable and/or encourage other users to view. As part of engaging with posted content, other users may comment and/or rate the content. These comments and ratings may in turn be used as a social signal to other users in the social networking system as to what content is particularly interesting or worthy of viewing. In some cases, these comments and ratings have been used to promote the visibility of the posted content. For example, the highest rated content may be moved to the top of a list of posted content, or the content that is the most popular as determined by generating the most views and/or comments may be identified in a hot topics list.

As social networking system users become familiar with ratings systems, there is a potential for such systems to be misused and/or abused such that comments and ratings no longer carry the desired social signal. Because providing comments and a high rating is essentially free to a user on conventional systems, there is little incentive for users to limit the number of high ratings that they dole out. Thus, it becomes difficult to separate truly valuable content from a potentially overwhelming amount of other highly rated content based on the ratings or comments.

### SUMMARY

In a social networking system environment, users can give another user credits, a scarce commodity, as part of commenting on content posted by the other user. These credits can be used as a peer-to-peer recommendation signal, and they can also be used as input to a decision engine that determines what content to display in a highlights section that will be viewed by a wider audience and increasing the likelihood of further engagement with the content. Credits in a social networking system environment have scarcity value. In various embodiments, in order to increase the number of credits in the system, users buy them or an administrator distributes a limited number of them. In some implementations, the total amount of credits in the system can decrease if a user cashes out the credits for real money. In some implementations, credits can be used to buy virtual or real-world gifts.

### BRIEF DESCRIPTION OF THE DRAWINGS

FIG. 1 is a high-level block diagram of the computing environment in accordance with an embodiment of the invention.

FIG. 2 is a high-level block diagram illustrating an example of a computer for use as a user device or a social network provider.

FIG. 3 is a block diagram illustrating components of the social network provider, in accordance with one embodiment.

FIG. 4 illustrates example messages that may be displayed to users who are able to give credits as part of commenting on content, in accordance with various embodiments.

FIGS. 5A and 5B illustrate a user interface for giving credits as part of commenting on content posted by a user.

FIG. 6 illustrates a highlights section of a user interface of the social networking system, in accordance with one embodiment.

FIG. 7 illustrates an example of the profile updates of a user who gives credits to others, in accordance with an embodiment.

FIG. 8 illustrates an example of the profile updates of a user who receives credits from others, in accordance with an embodiment.

FIG. 9A-C illustrates an example series of windows displayed to a user during the process of giving credits as part of commenting on posted content, in accordance with one embodiment.

FIG. 10 illustrates an example dialog box that is displayed to a user who does not have enough credits in an account to execute the desired transfer of credits to the user who posted the content, in accordance with an embodiment.

FIG. 11 illustrates an example notification received by a user who posted the content that another user gave credit, in accordance with an embodiment.

FIG. 12A illustrates an example window generated when a user spends credits to purchase a gift from the gift store, in accordance with an embodiment. FIG. 12B illustrates an example confirmation window for the purchase of the gift.

FIG. 13A illustrates an example window generated when a user selects a gift to purchase from the gift store, in accordance with an embodiment. FIG. 13B illustrates an example confirmation for the purchase of the gift illustrated in FIG. 13A.

FIG. 14A illustrates an example user interface for obtaining payment information for competing a gift purchase, in accordance with one embodiment. FIG. 14B illustrates an example confirmation for the gift purchase of FIG. 14A.

FIG. 15A illustrates an example user interface allowing a user to purchase additional credits when the user does not have sufficient credits to complete a desired transfer of credits to a user who posted content, in accordance with an embodiment. FIG. 15B illustrates an example confirmation for the purchase of credits illustrated in FIG. 15A.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

Embodiments of the present invention provide systems, methods, and computer-readable storage media for creating a social network economy using gifting credits. Credits in a social networking system environment have scarcity value. In various embodiments, in order to increase the number of credits in the system, users buy them or an administrator distributes a limited number of them. In some implementations, the total amount of credits in the system can decrease if a user cashes out the credits for real money. In some implementations, credits can be used to buy virtual or real-world gifts. Users can accumulate credits in a variety of ways. The user may receive credits from an administrator, they may buy them, they may receive them as gifts from other users as part of commenting on the user's posted content, or the user may receive credits as gifts from, for example, an advertiser in exchange for a desired behavior, such as having engaged with an advertisement.

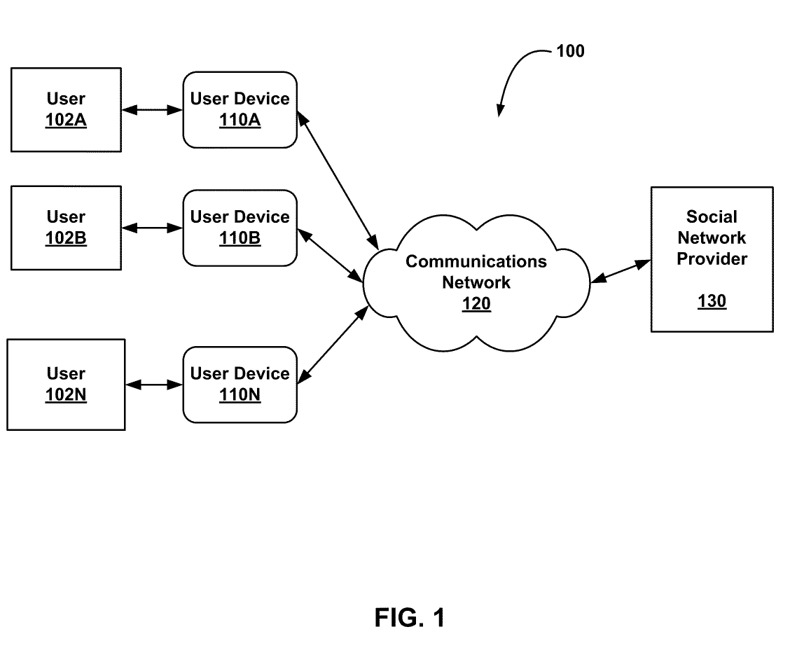

FIG. 1 is an illustration of a computing environment 100 in accordance with one embodiment of the invention. The computing environment 100 includes a plurality of users 102A-N at user devices 110A-N, that are coupled to a social network provider 130 via a communications network 120. In various embodiments, user devices 110 may include a computer terminal, a personal digital assistant (PDA), a wireless telephone, or various other user devices capable of connecting to the network 120. In various embodiments, the communications network 120 is a communications network such as a local area network (LAN), a wide area network (WAN), a wireless network, an intranet, or the Internet. In one embodiment, a user 102A purchases gifting credits from the social network provider 130 and gives them to a user 102B as part of commenting on content posted by user 102B via the social networking system environment 100. The recipient, i.e., user 102B can then use the received credits to comment on content posted by any user 102A-N, or in some embodiments, may use the acquired credits to purchase a virtual or real-world item through the social network provider 130. Examples of real-world gifts include but are not limited to gift certificates, movie tickets, gift subscriptions, downloadable files, software, music, or any real world object. Examples of virtual gifts include icons for display or trading, a digital image, an animation, virtual money, credits for use within gaming applications, or any other virtual object.

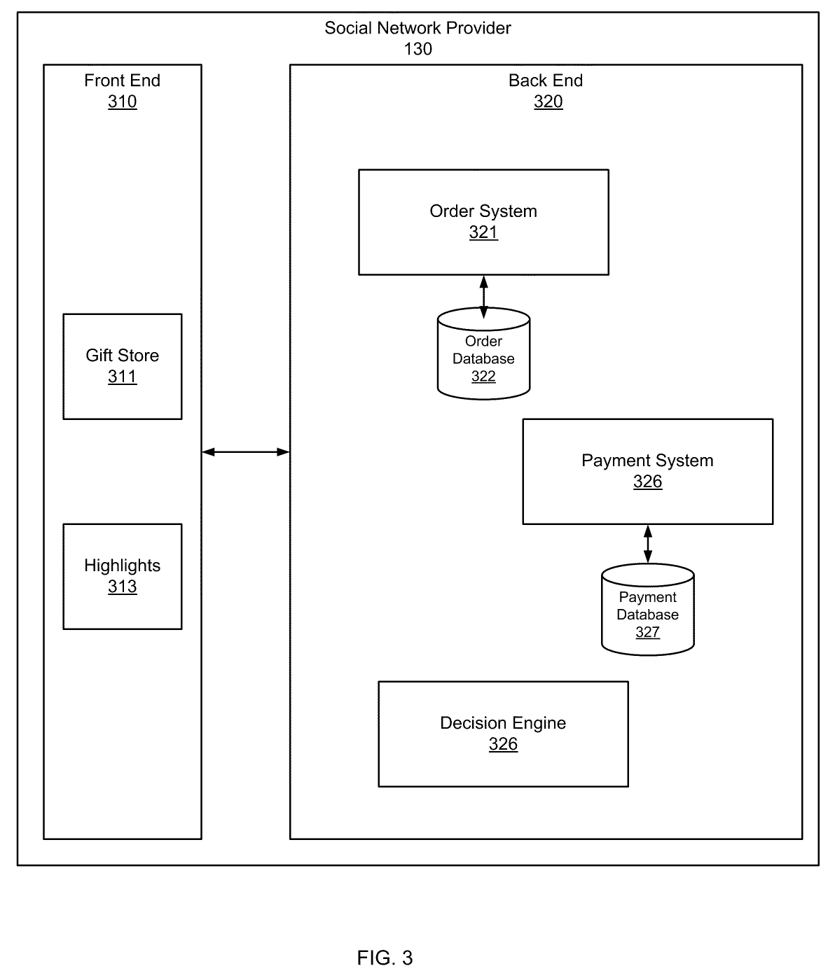

Each user 102A-N is represented by a profile in the social networking system environment 100. The profile may occupy an entire web page or a portion of a web page in the social networking system environment 100. The profile may include various fields relating the user 102, such as contact information, user identification, short news clips relating to the user, social information such as the user's friends and status, a list of photo albums, links, posts, notes, and/or various other content posted by the user. In one embodiment, a user is able to access a gift store as well as a highlights section from the user's profile webpage. The gift store and highlights will be described below with reference to FIG. 3. In some embodiments, the user is able to view on the user's profile an available credit balance in an account associated with the user, referred to herein as the user's account. Transactions involving credits facilitated through the user's account will be described with reference to FIGS. 3-15B below.

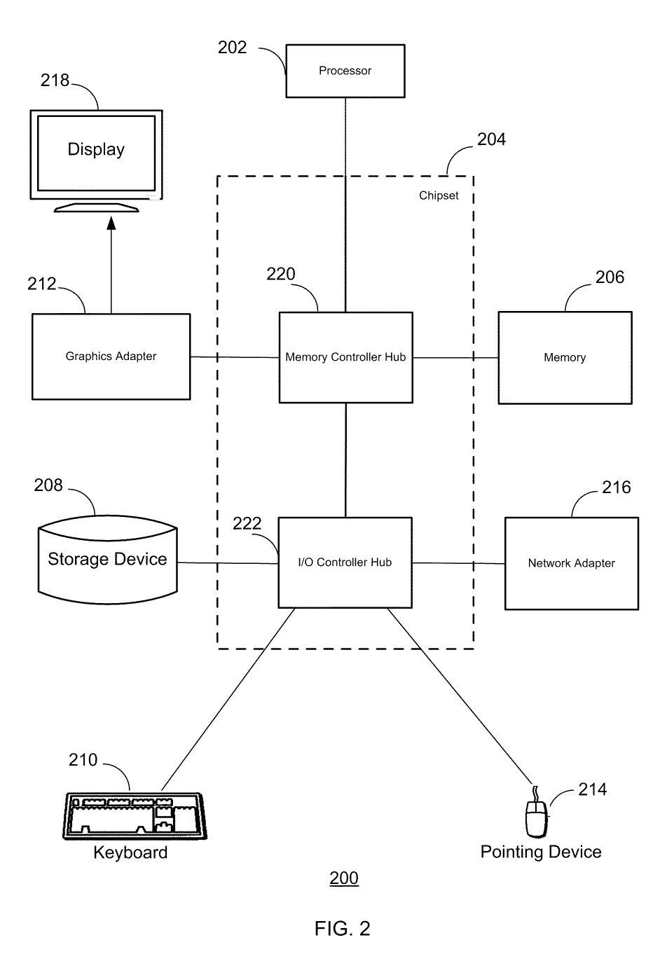

FIG. 2 is a high-level block diagram illustrating an example of a computer 200 for use as a user device 110A-N, and/or a social network provider 130. Illustrated are at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display device 218 is coupled to the graphics adapter 212. A storage device 208, keyboard 210, pointing device 214, and network adapter 216 are coupled to the I/O controller hub 222. Other embodiments of the computer 200 have different architectures. For example, the memory 206 is directly coupled to the processor 202 in some embodiments.

The storage device 208 is a computer-readable storage medium such as a hard drive, compact disk read-only memory (CD-ROM), DVD, or a solid-state memory device. The memory 206 holds instructions and data used by the processor 202. The pointing device 214 is a mouse, track ball, or other type of pointing device, and is used in combination with the keyboard 210 to input data into the computer system 200. The graphics adapter 212 displays images and other information on the display device 218. The network adapter 216 couples the computer system 200 to the communications network 120. Some embodiments of the computer 200 have different and/or other components than those shown in FIG. 2.

The computer 200 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202.

The types of computers 200 used by the entities of FIG. 1 can vary depending upon the embodiment and the processing power used by the entity. For example, a user device 110A-N that is a mobile telephone typically has limited processing power, a small display 218, and might lack a pointing device 214. The social network provider 130, in contrast, may comprise multiple blade servers working together to provide the functionality described herein.

FIG. 3 is a block diagram illustrating components of the social network provider 130, in accordance with one embodiment. The social network provider 130 includes a front end 310 and a back end 320. The front end 310 includes a gift store module 311 and a highlights module 313. The back end 320 includes an order system 321 coupled to at least one order database 322, a payment system 326 coupled to at least one payment database 327, and a decision engine. In some embodiments, portions depicted in FIG. 3 as being part of the social network provider 130 may be external to the social network provider. For example, a third party payment system 326 and payment database 327 may be used.

The social network provider 130 can be used to place and track orders for gifts or credits. The following description provides one example of a data flow in support of ordering gifts or credits. Other data flows may also be used, as will be apparent to one of ordinary skill in the art based on this disclosure.

An order of a gift or credits may be initiated by a user through the gift store module 311. When an order is initiated by a user through the gift store module 311, the order system 321 responds by creating a record in the order database 322, for example by inserting a row into an order table and marking it “initiated.” In some embodiments, the order system 321 may validate an order with a third party application. When an order is validated, an item row may be added to an item table in an order database 322. The order system 321 may then ask the user to confirm the purchase of the item. The user confirms the quantity and the price of the gift or credits that they are purchasing. When the user confirms the order, the order system 321 sends an authorization to charge the purchase amount to the payment system 326. The payment system creates a transaction record in the payment database 327, and marks it as “processing.” The payment amount (i.e., the purchase price in money or credits, or a combination of money and credits) is then debited from the user's account and recorded in the payment database 327. The payment system 326 confirms when the payment authorization is complete, at which time, the order system 321 marks the order as “placed” in the order database 322. In the case that a third party application is used to deliver the gift or credits, the order system 321 sends notification that the authorization is complete to the third party application, and requests that the goods be delivered. The third party application replies to the order system 321 when the goods have been delivered to the user. The order system 321 then directs the payment system 326 to capture the payment amount. The payment system 326 credits the payment amount to an account associated with the third party application in the payment database 327. The payment system also marks the transaction as “captured” in the payment database 327, and notifies the order system 321 that the capture is complete. The order system 321 subsequently marks the order as “settled” in the order database 322, and directs the gift store module 311 to notify the user that the gift or credits has been shipped or delivered. The user will then be able to access the gift or credits through their profile or account with the social network provider 130.

A user who has acquired credits, for example from other users, from an administrator, or through purchasing the credits, may choose to spend them by purchasing gifts through the gift store, as described above, or may use them as part of commenting on a user's posted content. A decision engine 326 uses the amount of credits received by each posted content as input to determine what posts to include in a highlights module 313 of the front end 310 of the social network provider 130. The decision engine 326 may use various preprogrammed rules for deciding the content to publicize as highlights. For example, the content that has received the most total number of credits may be publicized. The content that has received the most credits in a recent period of time may be publicized. The content that receives more than a high threshold number of credits from a user may be publicized. A variety of other rules may be used instead of or in combination with the examples above. Thus, credits can be used as a peer-to-peer recommendation signal, and they can also be used as input to a decision engine 326 that determines what content to display in a highlights section that will be viewed by a wider audience and increasing the likelihood of further engagement with the content.

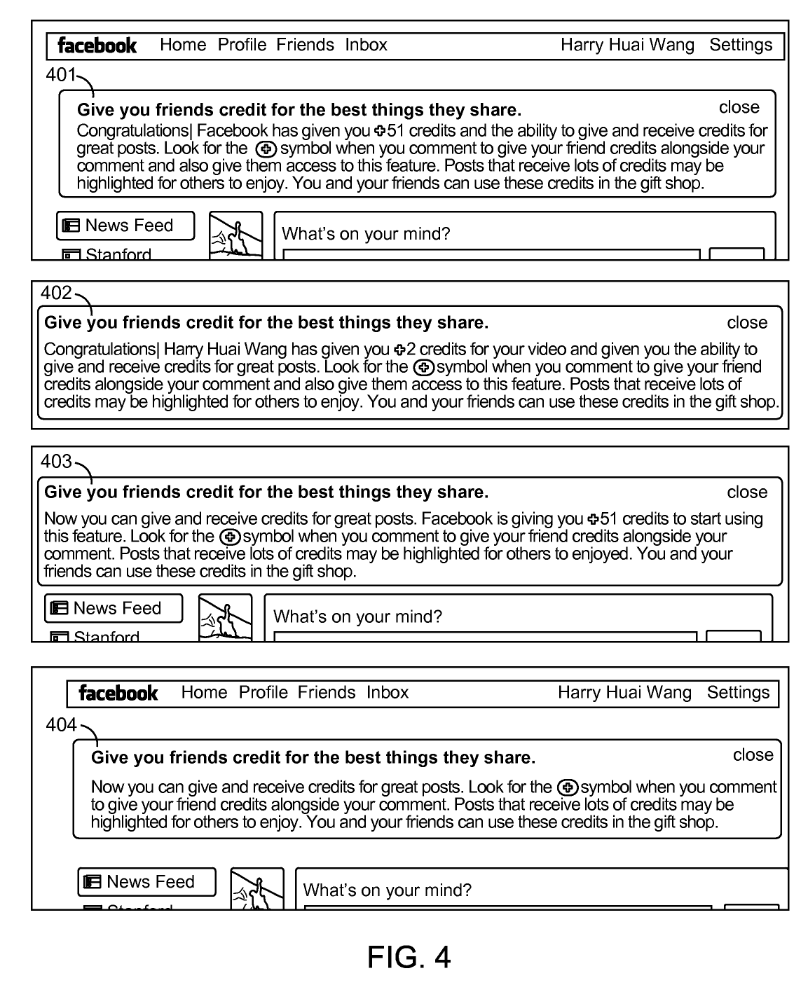

FIG. 4 illustrates several examples of messages 401, 402, 403, 404 that may be seen by users who are added to a group of users who are able to give credits as part of commenting on content. In the first example, an administrator has provided credits to some users of a social networking system. In the second example, a user with credits has given credits to another user. In the third example, credits are evenly distributed among a group of users of the social networking system. In the fourth example, no credits have been seeded by an administrator. Thus, users must buy credits in order to inject them into the social networking system economy. As these situations demonstrate, there are many ways to seed a social networking system with credits to begin the credit economy. In one embodiment, the credit economy is introduced into the social networking system without anyone receiving credits for free from an administrator. Thus, the economy relies on users to purchase starting quantities of credits. In another embodiment, an administrator gives a number of active users in a network several credits for free. For example, the top 10% of feedback providers may be given 50 credits. In yet another embodiment, an administrator may give everyone in the network a predetermined number of credits to introduce the credit economy. For example, every user may begin with 50 credits. In various other embodiments, combinations of these seeding strategies may be used to begin the credit economy.

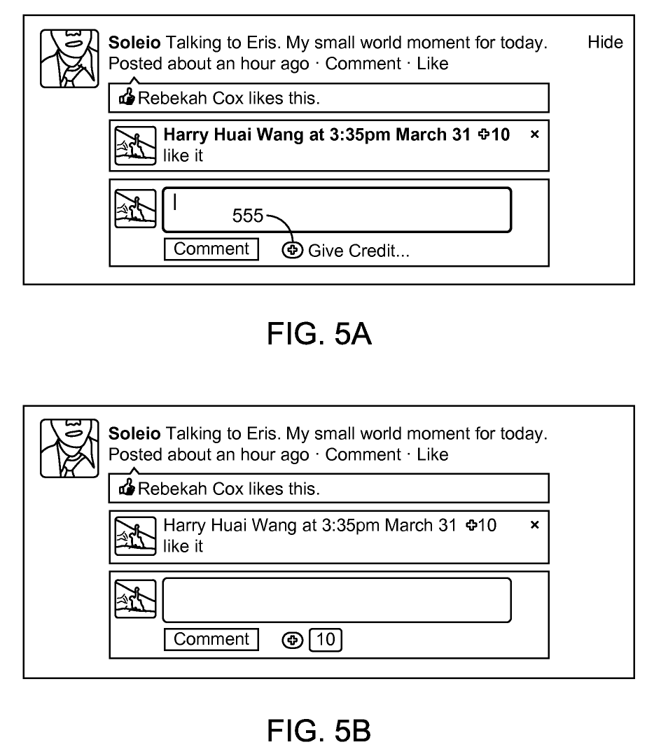

FIGS. 5A and 5B illustrate a user interface for giving credits as part of commenting on content posted by a user. FIG. 5A illustrates a comment window which allows a user to add text comments to a post made by a user. The user selects the “give credits” icon 555 if the user desires to include credits as part of the comment attached to the content posted. FIG. 5B illustrates the user interface of FIG. 5A after the user has selected the “give credits” icon 555. The user is then provided the ability to select the number of credits to give to the user who posted the content. In some embodiments, the user's balance of credits is displayed to the user. In this example, the commenting user has selected 10 credits to provide to the user who posted the content. In one embodiment, there is a preset minimum amount of credits needed to give credit to a user. In another embodiment, there is a maximum amount of credits allowed to be given to a user for one content posting as part of one comment, for example, to prevent costly mistakes by users. In some embodiments, only preset increments of credits may be given for ease of tracking.

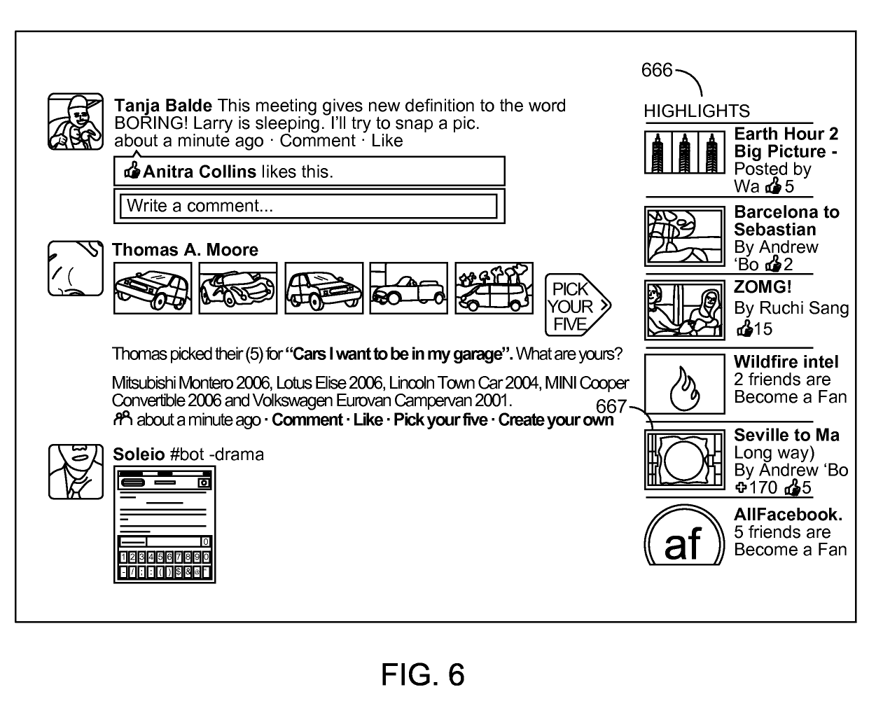

FIG. 6 illustrates a highlights section of a user interface of the social networking system. In this example, a content posting 667 has received 170 credits from users. Thus, it has been promoted to the highlights section 666 managed by the highlights module 313 by the decision engine 326 as content that has been signaled by peers to be worthy of attention. Because the highlights section 666 is displayed to a broader audience than an individual posting, it is likely that the inclusion of the content posting 667 in the highlights section 666 will result in further engagement with the posted content 667 by the users in the social networking system.

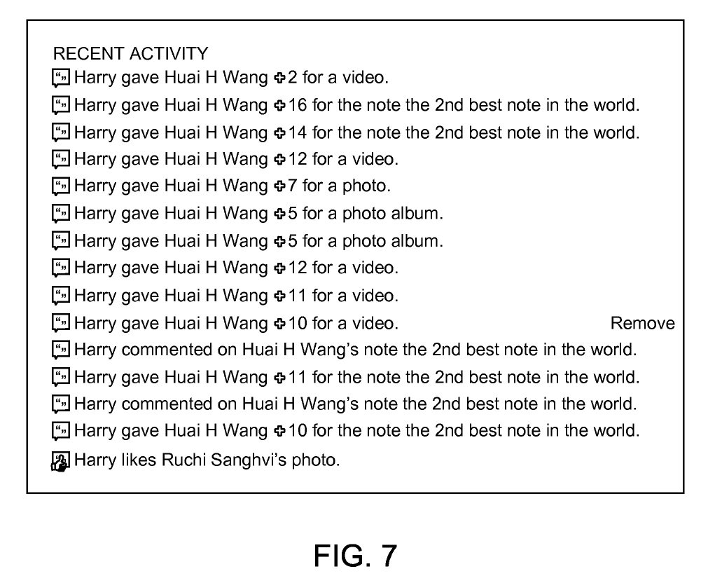

FIG. 7 illustrates an example of the profile updates of a user who gives credits to others. In this example, the recipient user, the amount of the credits, and the type of content is tracked for transactions involving credits.

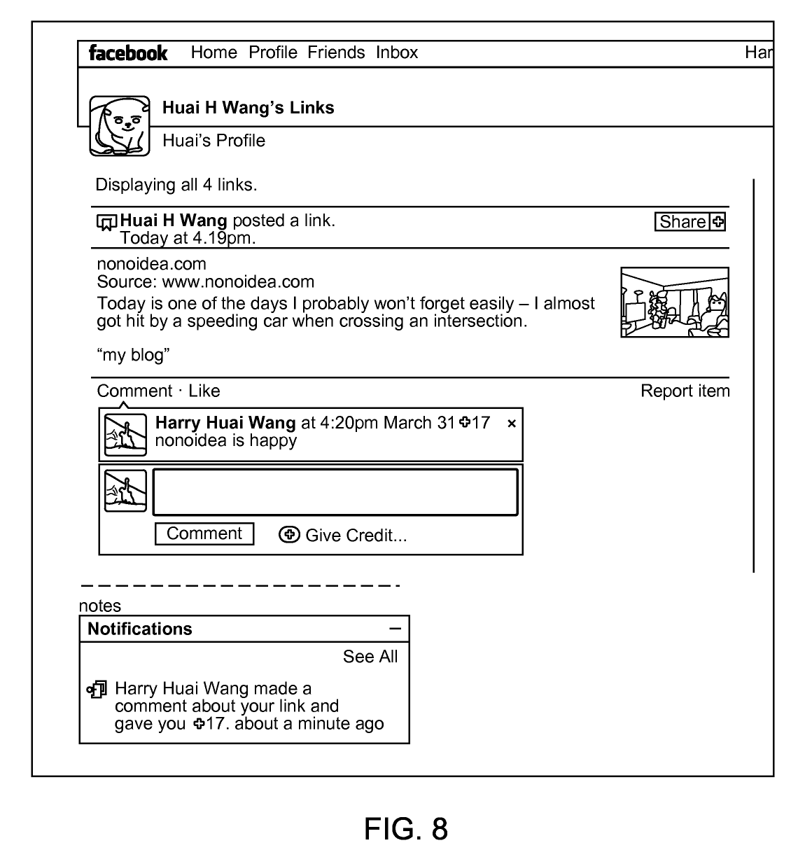

FIG. 8 illustrates an example of the profile updates of a user who receives credits from others. In this example, the credit amounts given are displayed next to the identity of the user who gives the credit. In some embodiments, the givers of credit can choose to remain anonymous to the receiving user. Also shown in FIG. 8 is an example notification displayed in a profile of the recipient of credits.

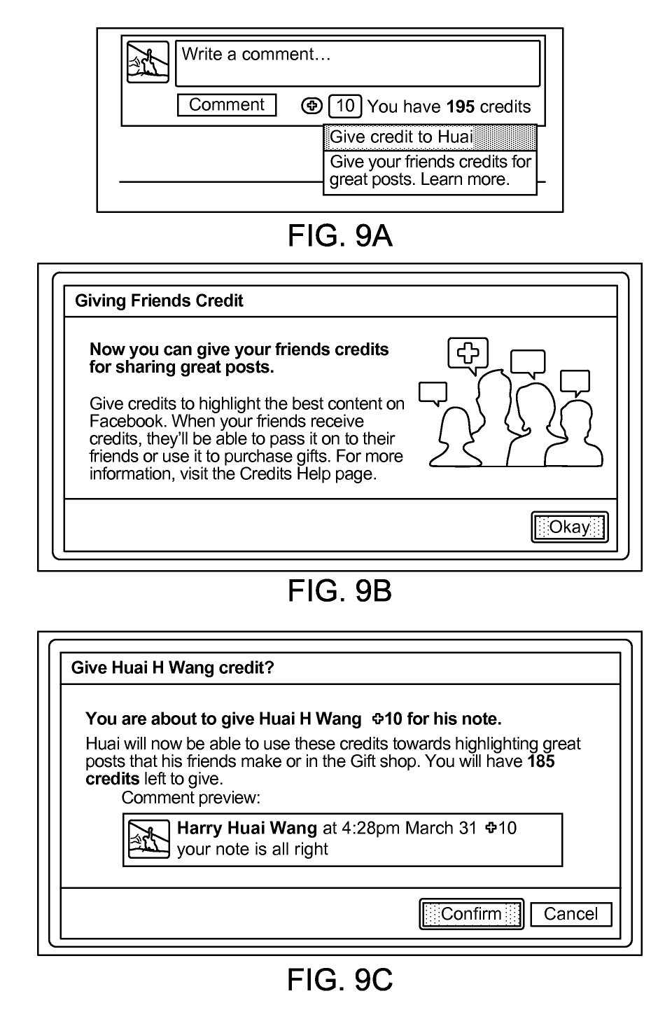

FIG. 9A-C illustrates an example series of windows displayed to a user during the process of giving credits as part of commenting on posted content. In FIG. 9A, the user selects an amount of credits to give to a user who posted the content from a total amount of credits that the giving user has acquired. FIG. 9B illustrates an example dialog box that describes the credit economy. If the user selects the okay button, FIG. 9C illustrates an example window that requests the user to confirm the transfer of credits to the user who posted the content. The user can select the button to confirm the transaction or can select the button to cancel the transaction.

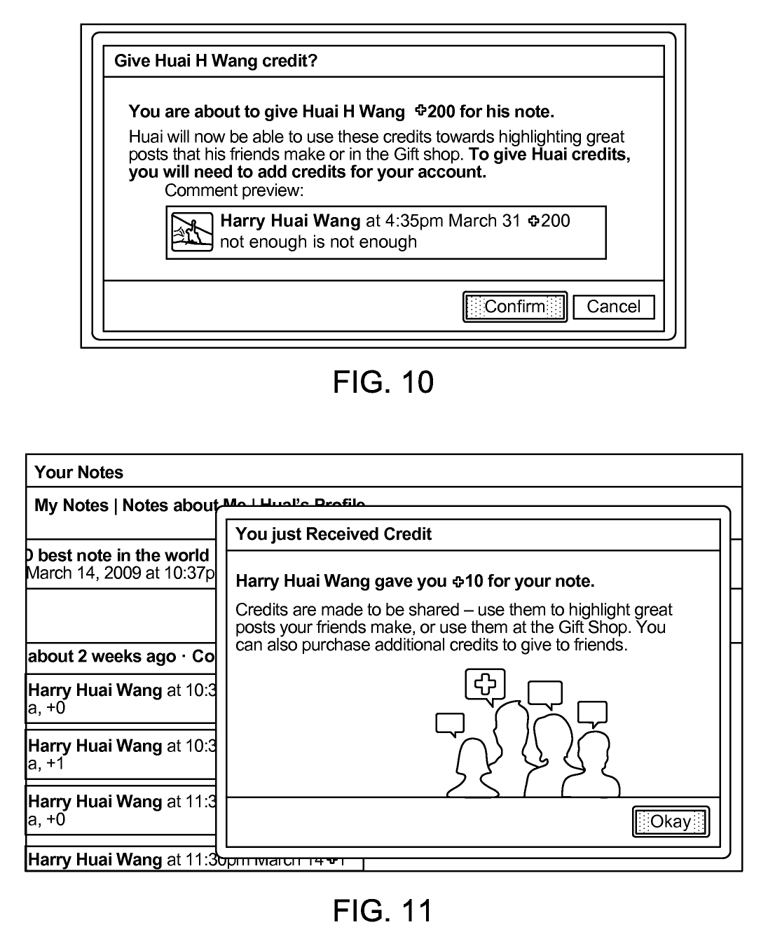

FIG. 10 illustrates an example dialog box that is displayed to a user who does not have enough credits in an account to execute the desired transfer of credits to the user who posted the content. The text instructs the user to add credits to the user's account before proceeding. The user can add credits to the user's account through purchasing them through the gift store described with reference to FIG. 3.

FIG. 11 illustrates an example notification received by a user who posted the content that another user gave credit. The notification may provide additional explanation of credits, how to acquire them, and how to use them.

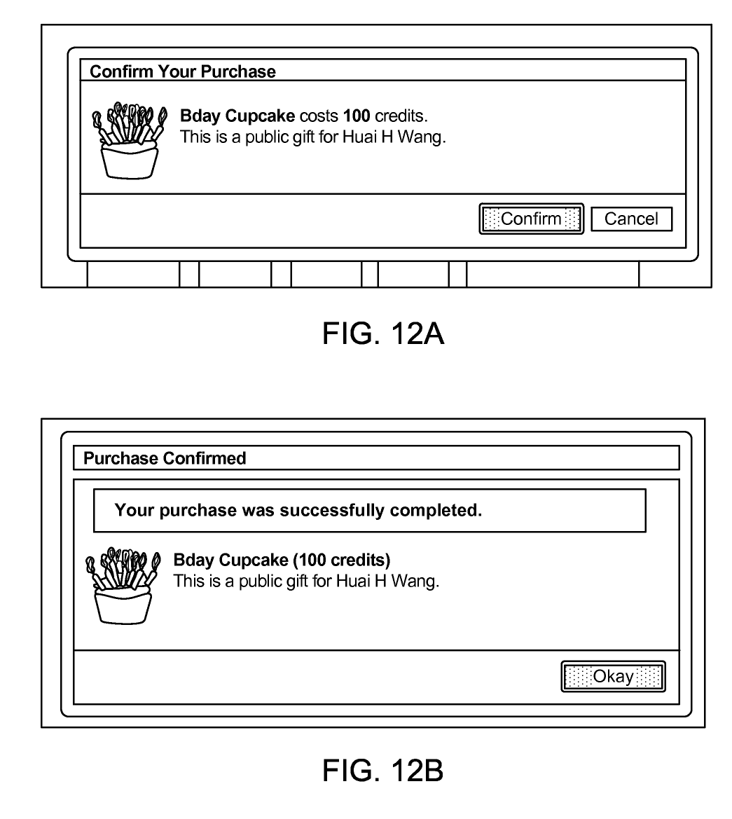

FIG. 12A illustrates an example window generated when a user spends credits to purchase a gift from the gift store 311. The gift may be given to any user and displayed in conjunction with the recipient's profile within the social networking system. FIG. 12B illustrates an example confirmation window for the purchase of the gift.

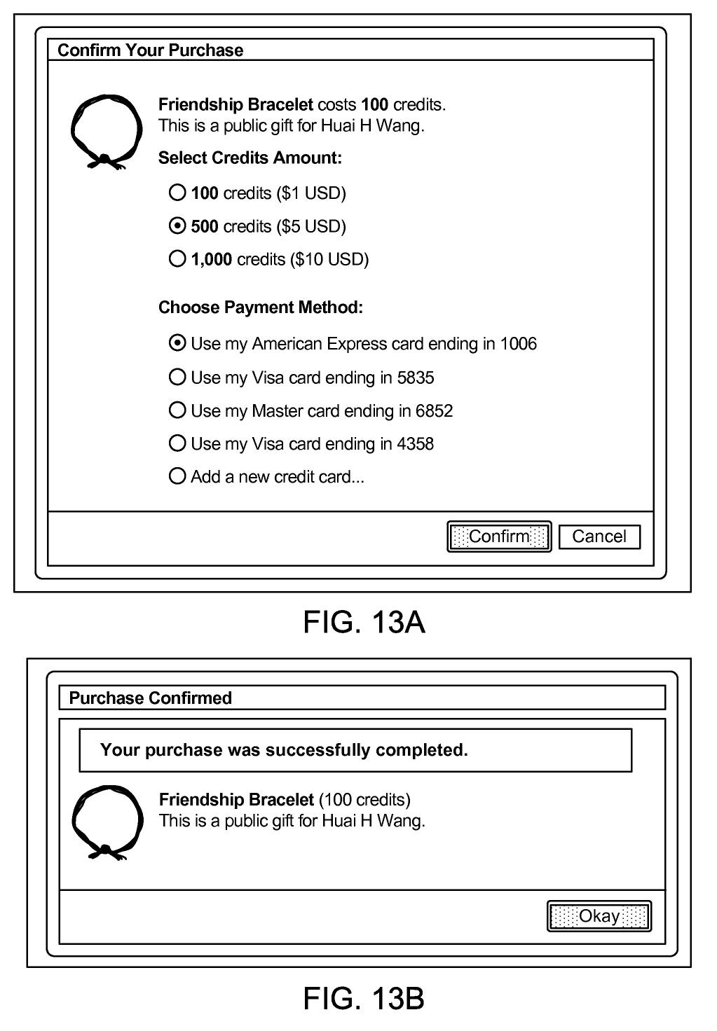

FIG. 13A illustrates an example window generated when a user selects a gift to purchase from the gift store 311. In this example, the user selects an amount of credits to purchase from the store using another payment method. The user may select to purchase more credits than needed for the specific desired purchase, and thus retain the balance. For example, if the user decides to purchase a gift costing 100 credits, the user may select to buy 500 credits by charging the cash value of the 500 credits on the user's credit card, for example. As a result of this transaction, the user would purchase the virtual gift for his or herself or for another user, and retain the 400 credits in the user's own account. FIG. 13B illustrates an example confirmation for the purchase of the gift illustrated in FIG. 13A.

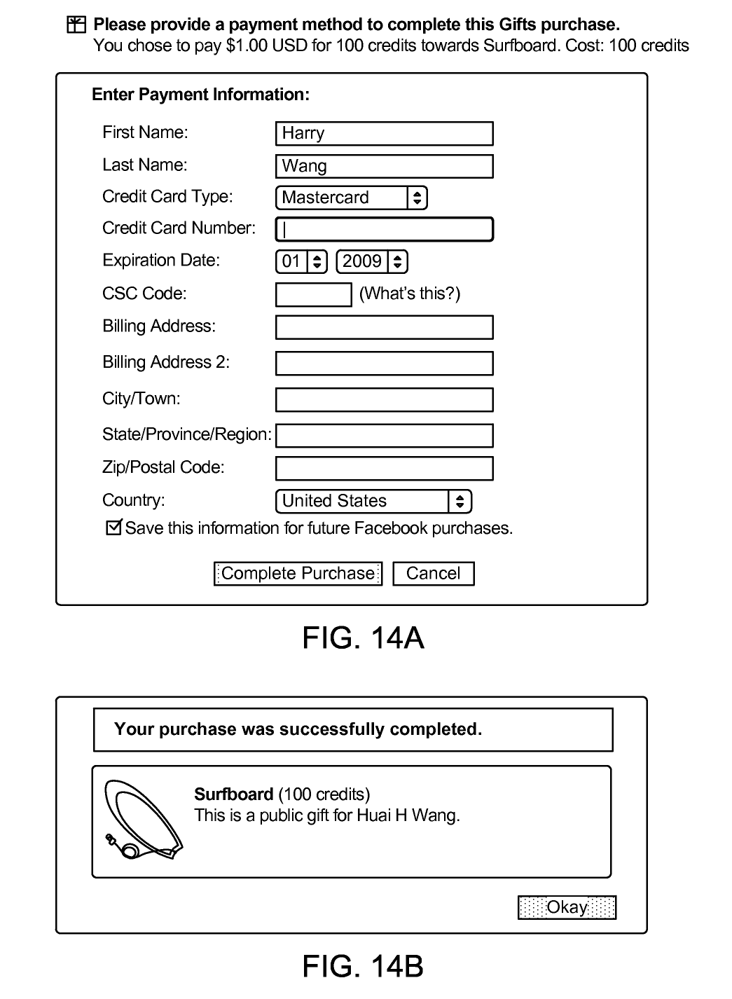

FIG. 14A illustrates an example user interface for obtaining payment information for competing a gift purchase, in accordance with one embodiment. FIG. 14B illustrates an example confirmation for the gift purchase of FIG. 14A.

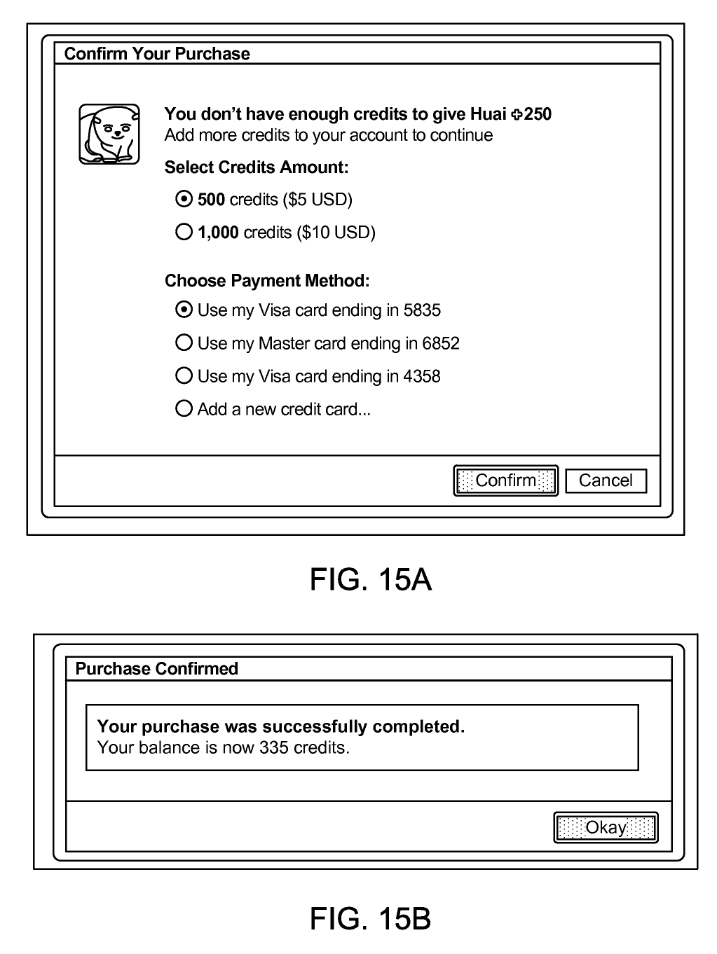

FIG. 15A illustrates an example user interface allowing a user to purchase additional credits when the user does not have sufficient credits to complete a desired transfer of credits to a user who posted content. The user interface allows the user to select an amount of credits and payment method. FIG. 15B illustrates an example confirmation for the purchase of credits illustrated in FIG. 15A.

The present invention has been described in particular detail with respect to several possible embodiments. Those of skill in the art will appreciate that the invention may be practiced in other embodiments. For example, embodiments of the invention have been described in the context of a social networking system. However, it is appreciated that embodiments of the invention may also be practiced in other communications network environments that include components to enable the purchasing, tracking, and gifting of credits as described above.

The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method of receiving user feedback on content in a social networking system, the method comprising:
maintaining an account of credits for each of a first user and a second user of a social networking system;
receiving content posted by a second user;
receiving, from the first user, a comment on the content posted by the second user, the comment associated with a number of credits to transfer from the first user's account to the second user's account; and
transferring the number of credits from the first user's account to the second user's account.

2. The method of claim 1, further comprising adding credits to the first user's account responsive to the first user buying credits from a social network provider.

3. The method of claim 1, further comprising adding credits to the first user's account responsive to the first user engaging with an advertisement.

4. The method of claim 1, further comprising adding credits to the first user's account responsive to an administrator distributing a limited number of credits.

5. The method of claim 1, wherein at least a portion of the credits in the first user's account are credits given by other users to the first user as part of the other users commenting on the first user's posted content.

6. The method of claim 1, wherein any user can spend credits in that user's account to purchase a real-world item selected from a group consisting of a gift certificate, movie ticket, gift subscription, downloadable file, software, and music.

7. The method of claim 1, wherein any user can spend credits in that user's account to purchase a virtual item selected from a group consisting of an icon for display or trading, a digital image, an animation, virtual money, and credits for use within a gaming application.

8. The method of claim 1, further comprising determining an item of content from among a plurality of items of content posted by users to publicize as a highlight based on a respective number of credits associated with comments on the item of content.

9. The method of claim 8, wherein the highlight is displayed in a highlight section of a web page of a social networking system that is displayed to a broader audience than an individual posting.

10. The method of claim 1, further comprising displaying, to other users, the number of credits associated with the comment by the first user on the content posted by the second user.

11. The method of claim 1, further comprising displaying, to a plurality of other users, an accumulated number of credits associated with comments by the first user and at least one other user on the content posted by the second user, the accumulated number of credits displayed in connection with the content posted by the second user.

12. The method of claim 1, wherein the number of credits associated with the comment from the first user must not exceed a threshold number of credits.

13. The method of claim 1, wherein comments only can be associated with numbers of credits in preset incremental amounts.

14. A method of receiving user feedback in a social networking system, the method comprising:
receiving content posted by a first user of a social networking system;
receiving, from a second user, in response to the content posted by the first user, an indication of a number of credits to transfer from the second user to the first user; and
transferring the number of credits from the second user to the first user.

15. The method of claim 14, further comprising determining an item of content from among a plurality of items of content posted by users to publicize more widely than others based on a respective number of credits received in response to the respective items of content.

16. The method of claim 14, further comprising determining an item of content from among a plurality of items of content posted by users to publicize as a highlight based on a respective number of credits received in response to the item of content.

17. The method of claim 16, wherein the highlight is displayed in a highlight section of a web page of a social networking system that is displayed to a broader audience than an individual posting.

18. A method of publicizing content in a social networking system, the method comprising:
determining an amount of credits received by posted content; and
publicizing content in the social networking system based on the amount of credits the content received.

19. The method of claim 18, wherein publicizing content in the social networking system based on the amount of credits the content received comprises publicizing content that received more than a threshold number of credits.

20. The method of claim 18, wherein publicizing content in the social networking system based on the amount of credits the content received comprises publicizing content that received more than a threshold number of credits within a recent period of time.

21. The method of claim 18, wherein publicizing content in the social networking system based on the amount of credits the content received comprises displaying the content to a wider audience.

22. A computer program product for receiving user feedback on content in a social networking system, the computer program product comprising a computer-readable storage medium containing computer program code for:
maintaining an account of credits for each of a first user and a second user of a social networking system;
receiving content posted by a second user;
receiving, from the first user, a comment on the content posted by the second user, the comment associated with a number of credits to transfer from the first user's account to the second user's account; and
transferring the number of credits from the first user's account to the second user's account.

23. The computer program product of claim 22, wherein the computer-readable storage medium further contains computer program code for:
determining an item of content from among a plurality of items of content posted by users to publicize to a broader audience based on a respective number of credits associated with comments on the item of content.

24. A computer program product for receiving user feedback in a social networking system, the computer program product comprising a computer-readable storage medium containing computer program code for:
receiving content posted by a first user of a social networking system;
receiving, from a second user, in response to the content posted by the first user, an indication of a number of credits to transfer from the second user to the first user; and
transferring the number of credits from the second user to the first user.

25. The computer program product of claim 24, wherein the computer-readable storage medium further contains computer program code for:
determining an item of content from among a plurality of items of content posted by users to publicize more widely than others based on a respective number of credits received in response to the respective items of content.

26. A computer program product for publicizing content in a social networking system, the computer program product comprising a computer-readable storage medium containing computer program code for:
determining an amount of credits received by posted content; and
publicizing content in the social networking system based on the amount of credits the content received.

27. The computer program product of claim 26 wherein publicizing content in the social networking system based on the amount of credits the content received comprises publicizing content that received more than a threshold number of credits.
